(19) United States
(12) Patent Application Publication
(10) Pub. No.: US 2026/0162180 A1
(43) Pub. Date: Jun. 11, 2026

(54) METHOD AND SYSTEM FOR MATCHING SUPPLIERS AND CONSUMERS FOR ONLINE PEER TO PEER ENERGY TRANSACTION BETWEEN PRODUCERS AND CONSUMERS WITHIN COMMUNITY

(71) Applicant: Korea Electronics Technology Institute, Seongnam-si (KR)

(72) Inventors: Yong Kuk PARK, Seoul (KR); Min Goo LEE, Seoul (KR)

(73) Assignee: Korea Electronics Technology Institute, Seongnam-si (KR)

(21) Appl. No.: 19/182,004

(22) Filed: Apr. 17, 2025

(30) Foreign Application Priority Data
Jun. 28, 2024 (KR) 10-2024-0085083

(51) Int. Cl. G06Q 40/04; G06Q 50/06

(52) U.S. Cl. CPC G06Q 40/0451; G06Q 50/06

(57) ABSTRACT

Provided are a method and a system for online P2P energy transaction. A method for matching suppliers and consumers for online P2P energy transaction may include: collecting, by a matching system, information on a transaction range presented by an offer from a supplier, and information on a transaction range presented by a bid from a consumer; and determining, by the matching system, an optimal transaction volume between the supplier and the consumer, based on the information on the transaction ranges of the offer and the bid. Accordingly, easier and faster matching may be provided between an offer from a supplier and a bid from a consumer in energy transaction.

### CROSS-REFERENCE TO RELATED APPLICATION(S) AND CLAIM OF PRIORITY

This application is based on and claims priority under 35 U.S.C. § 119 to Korean Patent Application No. 10-2024-0085083, filed on Jun. 28, 2024, in the Korean Intellectual Property Office, the disclosure of which is herein incorporated by reference in its entirety.

### BACKGROUND

### Field

The disclosure relates to a method and a system for online peer to peer (P2P) energy transaction, and more particularly, to a method for matching suppliers and consumers for online P2P energy transaction between producers and consumers in communities.

### Description of Related Art

Currently, P2P two-way energy transaction services between prosumers and consumers are operated in various online platforms domestically and internationally.

Most of the transaction methods in existing operation platforms are mainly based on auction-based bidding or contracts between energy suppliers and consumers.

In a related-art auction-based bidding method, energy suppliers and consumers may write transaction volumes and transaction prices that they wish to transact in offers and bids, respectively, and may submit the offers and the bids online, and an online P2P energy transaction platform may use a 1:1 matching method of one offer to one bid as the simplest way for matching suppliers and consumers for energy transaction.

Accordingly, the offers and bids of suppliers and consumers are searched and matched to achieve an optimal 1:1 match based on the transaction volumes and transaction prices of the submitted offers and bids, and in this case, a method of matching to satisfy both the transaction volume and the transaction price or satisfy the transaction price or transaction volume may be used.

However, when such offers and bids are matched 1:1, it may take a long time to match a bid and an offer that have the exact same value to satisfy both the transaction volume and the transaction price or satisfy one of the transaction price or the transaction volume, and in some cases, there may be no completely matched bit and offer and there is a problem that many bids and offers cannot be matched in time.

### SUMMARY

The disclosure has been developed in order to solve the above-described problems, and an object of the disclosure is to provide a method and a system for matching that provide easier and faster matching between the offers of suppliers and the bids of consumers in energy transactions than related-art methods.

To achieve the above-described object, a method for matching suppliers and consumers for online P2P energy transaction may include: collecting, by a matching system, information on a transaction range presented by an offer from a supplier, and information on a transaction range presented by a bid from a consumer; and determining, by the matching system, an optimal transaction volume between the supplier and the consumer, based on the information on the transaction ranges of the offer and the bid.

Determining the optimal transaction volume may include selecting a matchable bid with reference to the transaction range of the offer, and, when a plurality of bids are selected, determining an optimal transaction bid by considering transaction volumes and transaction prices of the plurality of bids, respectively.

Determining the optimal transaction volume may include: primarily selecting a matchable bid with reference to the transaction range on the transaction volume of the offer; when a plurality of bids are primarily selected, prioritizing the bids from highest to lowest transaction volume and setting a rating for each bid; secondarily selecting a matchable bid from the primarily selected bids with reference to a minimum transaction price of the offer; when a plurality of bids are secondarily selected, prioritizing the bids from highest to lowest transaction price and setting a rating for each bid; calculating a final score of each bid by adding up the transaction volume-based rating score and the transaction price-based rating score; and determining a bid that has the highest final score as the optimal transaction bid.

Selecting the matchable bid may include, when there is an overlapping value between the transaction range presented by the offer from the supplier and the transaction range presented by the bid from the consumer, selecting the corresponding bid as the matchable bid, and the transaction volume of each of the bids selected may be determined by a largest value among the overlapping values.

Calculating the final score may include, when a seller sets a weight to one item of the transaction volume and the transaction price, calculating the final score for each bid by giving a weight to the rating score of the item to which the weight is set.

The matching system may be configured to register a plurality of offers from a supplier participating in matching for online P2P energy transaction, each of the offers may include information on a transaction range of transaction volumes and a minimum transaction price which are individually determined, and the matching system may be configured to, when the plurality of offers registered by the same supplier are prioritized for matching by the corresponding supplier, make the offers participate in matching in sequence from the highest priority offer, and, when one offer is matched, make the subordinate offers abstain from participating in matching.

In addition, the matching system may be configured to: when a first offer of the supplier is registered, select information on the same or similar transaction history from previous transaction histories with reference to a transaction range or a minimum transaction price of the registered first offer, and recommend a calibration value for the transaction range or the minimum transaction price in the registered first offer; and, when the supplier agrees with the calibration on the transaction range or the minimum transaction price, set a second offer that results from calibration with the recommended calibration value for the transaction range or the minimum transaction price as a subordinate to the first offer, and register as the offer of the corresponding supplier.

In addition, the matching system may be configured to register a plurality of bids from a consumer participating in matching for online P2P energy transaction, each of the bids may include information on a transaction range of transaction volumes and a transaction range of transaction prices which are individually determined, and the matching system may be configured to, when the plurality of bids registered by the same consumer are prioritized for matching by the corresponding consumer, make the bids participate in matching in sequence from the highest priority bid, and, when one bid is matched, make the subordinate bids abstain from participating in matching.

The matching system may be configured to: when a first bid of the consumer is registered, select information on the same or similar transaction history from previous transaction histories with reference to a transaction range or a minimum transaction price of the registered first bid, and recommend a calibration value for the transaction range of the transaction volumes or the transaction range of the transaction prices in the registered first bid; and, when the consumer agrees with the calibration on the transaction range of the transaction volumes or the transaction range of the transaction prices, set a second bid that results from calibration with the recommended calibration value for the transaction range of the transaction volumes or the transaction range of the transaction prices as a subordinate to the first bid, and register as the bid of the corresponding consumer.

According to another embodiment of the disclosure, a system for matching suppliers and consumers for online P2P energy transaction may include: a collection unit configured to collect information on a transaction range presented by an offer from a supplier, and information on a transaction range presented by a bid from a consumer; and a processor configured to determine an optimal transaction volume between the supplier and the consumer, based on the information on the transaction ranges of the offer and the bid.

According to still another embodiment of the disclosure, a method for matching suppliers and consumers for online P2P energy transaction may include: selecting, by a matching system, a matchable bid with reference to a transaction range of an offer by using information on a transaction range presented by an offer from a supplier, and information on a transaction range presented by a bid from a consumer, and, when a plurality of bids are selected, determining, by the matching system, an optimal transaction bid by considering transaction volumes and transaction prices of the plurality of bids, respectively.

According to embodiments of the disclosure as described above, the speed of an overall matching process may be enhanced through easier and faster matching between an offer from a supplier and a bid from a consumer in energy transaction.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a method for matching suppliers and consumers for online P2P energy transaction according to an embodiment of the disclosure;

FIG. 2 is a view provided to explain an optimal transaction volume determination process in the method for matching suppliers and consumers for online P2P energy transaction, shown in FIG. 1, in more detail;

FIG. 3 is a view illustrating transaction ranges of offers and bids to explain an optimal matching transaction volume determination process according to an embodiment of the disclosure;

FIG. 4 is a view provided to explain a system for matching suppliers and consumers for online P2P energy transaction according to an embodiment of the disclosure;

FIG. 5 is a view illustrating a plurality of offers that are registered from the same supplier in the system for matching suppliers and consumers for online P2P energy transaction according to an embodiment of the disclosure; and

FIG. 6 is a view illustrating a plurality of bids that are registered from the same consumer in the system for matching suppliers and consumers for online P2P energy transaction according to an embodiment of the disclosure.

### DETAILED DESCRIPTION

Hereinafter, the disclosure will be described in more detail with reference to the accompanying drawings.

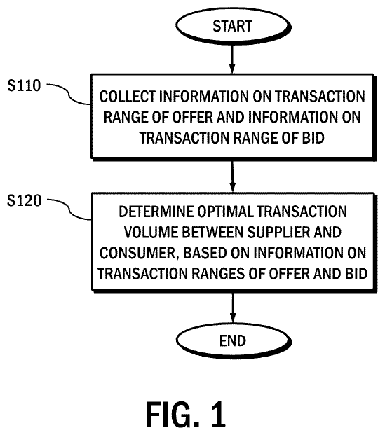

FIG. 1 is a view provided to explain a method for matching suppliers and consumers for online P2P energy transaction according to an embodiment of the disclosure.

The method for matching suppliers and consumers for online P2P energy transaction according to the present embodiment (hereinafter, referred to as a ‘matching method’) may set transaction ranges of transaction volumes and transaction prices in which a supplier and a consumer can transact, compared to a related-art method of setting only one value for each of a transaction volume and a transaction price in a bid and an offer, so that the number of matched pairs may increase and the speed of a matching process between a bid and an offer may be enhanced.

Specifically, the matching method according to the present embodiment may perform matching by collecting information on a transaction range presented by an offer from a supplier via a matching system, and information on a transaction range presented by a bid from a consumer (S110), and determining an optimal transaction volume between the supplier and the consumer based on the information on the transaction ranges of the offer and the bid (S120).

In this case, in the process of determining the optimal transaction volume, the matching method may select a matchable bid with reference to the transaction range of the offer, and, when a plurality of bids are selected, may determine an optimal transaction bid by considering the transaction volumes and transaction prices of the plurality of bids, respectively.

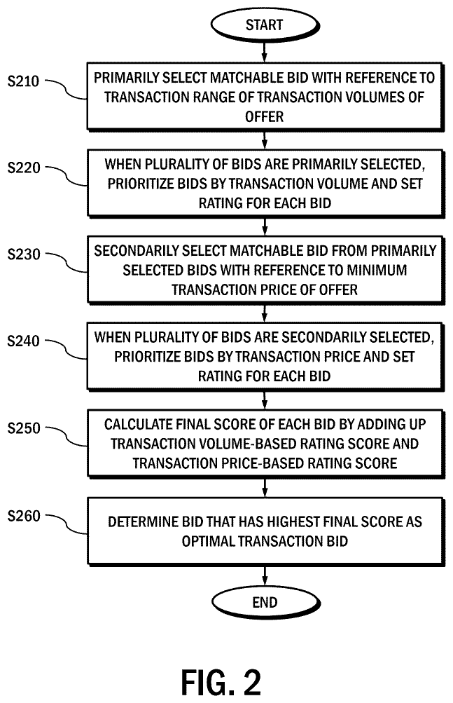

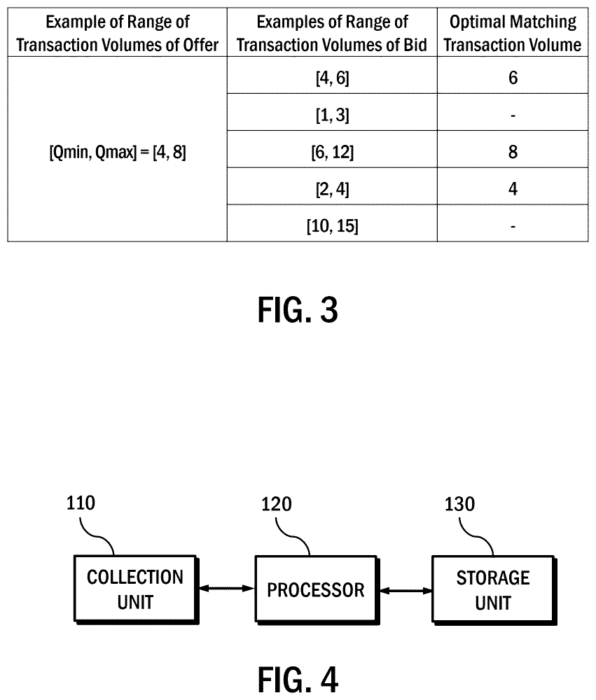

FIG. 2 is a view provided to explain the process of determining the optimal transaction volume in the method of matching the supplier and the consumer for online P2P energy transaction shown in FIG. 1, and FIG. 3 is a view illustrating examples of transaction ranges of the offer and the bid to explain the optimal matching transaction volume determination process according to an embodiment of the disclosure.

Referring to FIG. 2, in order to determine an optimal transaction volume, the matching method according to the present embodiment may primarily select a matchable bid with reference to the transaction range on the transaction volume of the offer (S210), and, when a plurality of bids are primarily selected, may prioritized the bids from highest to lowest transaction volume and may set a rating for each bid (S220).

Thereafter, the matching method may secondarily select a matchable bid from the primarily selected bids with reference to a minimum transaction price of the offer (S230), and, when a plurality of bids are secondarily selected, may prioritize the bids from highest to lowest transaction price, and may set a rating for each bid (S240), and may calculate a final score of each bid by adding up the transaction volume-based rating score and the transaction price-based rating score (S250), and may determine the bid that has the highest final score as an optimal transaction bid (S260).

Here, when there is an overlapping value between the transaction range presented by the offer of the supplier and the transaction range presented by the bid of the consumer, the matching method may select the corresponding bid as a matchable bid. In this case, the transaction volume of each bid selected may be determined by the largest value among the overlapping values.

Referring to FIG. 3, when the transaction range on the transaction volume of the offer that is registered at the matching system is [4, 8] and the transaction ranges on the transaction volumes of the bids that are registered at the matching system are [4, 6], [1, 3], [6, 12], [2, 4], [10, 15], the primarily selected bids may be [4, 6], [6, 12], [2, 4]. The transaction volumes of the bids primarily selected (optimal matching transaction volume) may be 6, 8, 4, respectively, which are the largest values of the overlapping values.

Accordingly, the transaction volume-based rating scores of the primarily selected bids may be determined, such that the bid in the range [6, 12] has the highest rating score, the bid in the range [4, 6] has the next highest rating score, and the bid in the range [2, 4] has the lowest rating score.

If the minimum transaction price of the offer is set to 2, only the bids with the maximum value in the transaction range of the transaction price that is higher than 2 may be secondarily selected among the primarily selected bids, except for the bids with the maximum value in the transaction range of the transaction price that is lower than 2, and the secondarily selected bids may be prioritized from highest to lowest transaction price and a rating may be set for each bid.

Here, the matching system may calculate a final score by uniformly adding up the transaction volume-based rating score and the transaction price-based rating score, but, when a seller sets a weight to one of the transaction volume and the transaction price, a weight may be given to the rating score of the weighted item and a final score may be calculated for each bid.

That is, when the seller sets a weight to the transaction volume or the transaction price, the matching system may determine a bid that has the highest rating score with reference to the weighted transaction volume or transaction price as an optimal transaction bid, and, when there are a plurality of bids that have the same weighted rating score, the optimal transaction bid may be determined with reference to the rating score without the weight.

FIG. 4 is a view provided to explain a system for matching suppliers and consumers for online P2P energy transaction according to an embodiment of the disclosure.

The system for matching suppliers and consumers for online P2P energy transaction according to an embodiment (hereinafter, referred to as a ‘matching system’) is provided to perform the matching method described above with reference to FIGS. 1 to 3.

To achieve this, the matching system may include a collection unit 110, a processor 120, and a storage unit 130.

The collection unit 110 may be provided with a communication means connected with an external server for power transaction, terminals of consumers and terminals of prosumers to collect data necessary for operations of the processor 120.

For example, the collection unit 110 may collect information on a transaction range presented by an offer from a supplier, and information on a transaction range presented by a bid from a consumer.

The storage unit 130 is a storage medium that stores data and programs necessary for operations of the processor 120.

The processor 120 may be provided to process overall matters of the matching system.

For example, the processor 120 may determine an optimal transaction volume between the supplier and the consumer based on the information on the transaction ranges of the offer and the bid.

Specifically, the processor 120 may select matchable bids with reference to the transaction range of the offer by using the information on the transaction range presented by the offer from the supplier and the information on the transaction range presented by the bid from the consumer, and, when a plurality of bids are selected, may determine an optimal transaction bid by considering the transaction volumes and the transaction prices of the plurality of bids, respectively.

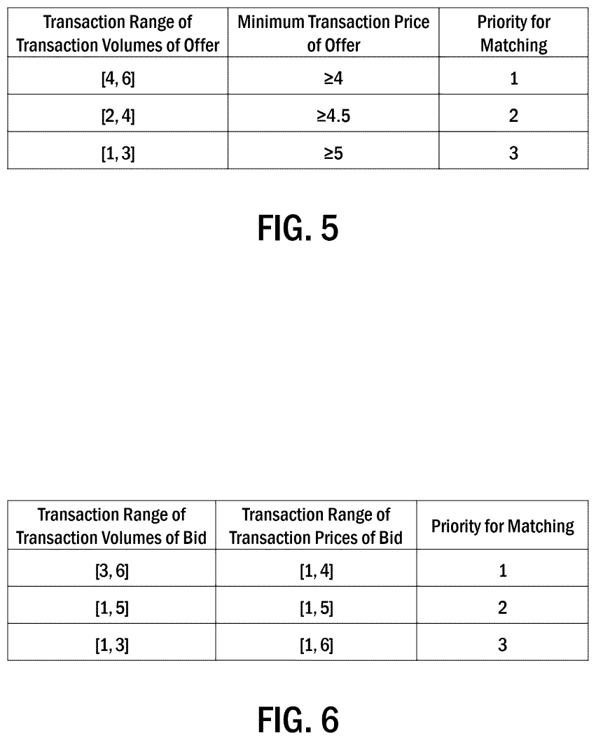

FIG. 5 is a view illustrating a plurality of offers that are registered at the matching system from the same supplier according to an embodiment of the disclosure.

Referring to FIG. 5, the matching system according to the present embodiment may allow a supplier participating in matching for online P2P energy transaction to register a plurality of offers. That is, each of the suppliers may register a plurality of offers.

In this case, each of the offers registered may include information on a transaction range of transaction volumes and a minimum transaction price which are individually determined.

When the plurality of offers registered by the same supplier are prioritized for matching by the corresponding supplier, the matching system may make the offers participate in matching in sequence from the highest priority offer, and, when one offer is matched, may make the subordinate offers abstain from participating in matching.

For example, when a specific supplier registers three offers as shown in FIG. 5, the matching system may allow the offers to participate in matching from the highest priority offer (for example, offer 1) according to information on the transaction range of the transaction volumes and the minimum transaction price of each offer, and the priority, and, when matching of offer 1 fails, may allow offer 2 and offer 3 to participate in matching in sequence. When matching of offer 1 succeeds, offer 2 and offer 3 may abstain from participating in matching.

When a first offer of a supplier is registered, the matching system may select information on the same or similar transaction history from previous transaction histories with reference to the transaction range or the minimum transaction price of the registered first offer, and may recommend a calibration value for the transaction range or the minimum transaction price in the registered first offer.

In this case, when the supplier agrees with the calibration on the transaction range or the minimum transaction price, the matching system may set a second offer that results from calibration with the recommended calibration value for the transaction range or the minimum transaction price as a subordinate to the first offer, and may register it as an offer of the corresponding supplier. Through this, the number of offers from the supplier may increase, so that the matching success rate may be improved.

FIG. 6 is a view illustrating a plurality of bids that are registered at the matching system from the same consumer according to an embodiment of the disclosure.

Referring to FIG. 6, the matching system may allow a consumer participating in matching for online P2P energy transaction to register a plurality of bids.

In this case, each of the bids registered may include information on a transaction range of transaction volumes and a transaction range of transaction prices which are individually determined.

When the plurality of bids registered by the same consumer are prioritized for matching by the corresponding consumer, the matching system may make the bids participate in matching in sequence from the highest priority bid, and, when one bid is matched, may make the subordinate bids abstain from matching.

For example, when a specific consumer registers three bids as shown in FIG. 6, the matching system may allow the bids to participate in matching from the highest priority bid (for example, bid 1) according to information on the transaction range of the transaction volumes and the transaction range of the transaction prices of each bid, and the priority, and, when matching of bid 1 fails, may allow bid 2 and bid 3 to participate in matching in sequence. When matching of bid 1 succeeds, bid 2 and bid 3 may abstain from participating in matching.

When a first bid of a consumer is registered, the matching system may select information on the same or similar transaction history from previous transaction histories with reference to the transaction range or the minimum transaction price of the registered first bid, and may recommend a calibration value for the transaction range of the transaction volumes or the transaction range of the transaction prices in the registered first bid.

In this case, when the consumer agrees with the calibration on the transaction range of the transaction volumes or the transaction range of the transaction prices, the matching system may set a second bid that results from calibration with the recommended calibration value for the transaction range of the transaction volume or the transaction range of the transaction price as a subordinate to the first bid, and may register it as a bid of the corresponding consumer. Through this, the number of bids from the consumer may increase, so that the matching success rate may be improved.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A method for matching suppliers and consumers for online P2P energy transaction, the method comprising:
collecting, by a matching system, information on a transaction range presented by an offer from a supplier, and information on a transaction range presented by a bid from a consumer; and
determining, by the matching system, an optimal transaction volume between the supplier and the consumer, based on the information on the transaction ranges of the offer and the bid.

2. The method of claim 1, wherein determining the optimal transaction volume comprises selecting a matchable bid with reference to the transaction range of the offer, and, when a plurality of bids are selected, determining an optimal transaction bid by considering transaction volumes and transaction prices of the plurality of bids, respectively.

3. The method of claim 2, wherein determining the optimal transaction volume comprises:
primarily selecting a matchable bid with reference to the transaction range on the transaction volume of the offer;
when a plurality of bids are primarily selected, prioritizing the bids from highest to lowest transaction volume and setting a rating for each bid;
secondarily selecting a matchable bid from the primarily selected bids with reference to a minimum transaction price of the offer;
when a plurality of bids are secondarily selected, prioritizing the bids from highest to lowest transaction price and setting a rating for each bid;
calculating a final score of each bid by adding up the transaction volume-based rating score and the transaction price-based rating score; and
determining a bid that has the highest final score as the optimal transaction bid.

4. The method of claim 3, wherein selecting the matchable bid comprises, when there is an overlapping value between the transaction range presented by the offer from the supplier and the transaction range presented by the bid from the consumer, selecting the corresponding bid as the matchable bid, and
wherein the transaction volume of each of the bids selected is determined by a largest value among the overlapping values.

5. The method of claim 3, wherein calculating the final score comprises, when a seller sets a weight to one item of the transaction volume and the transaction price, calculating the final score for each bid by giving a weight to the rating score of the item to which the weight is set.

6. The method of claim 1, wherein the matching system is configured to register a plurality of offers from a supplier participating in matching for online P2P energy transaction,
wherein each of the offers comprises information on a transaction range of transaction volumes and a minimum transaction price which are individually determined, and
wherein the matching system is configured to, when the plurality of offers registered by the same supplier are prioritized for matching by the corresponding supplier, make the offers participate in matching in sequence from the highest priority offer, and, when one offer is matched, make the subordinate offers abstain from participating in matching.

7. The method of claim 6, wherein the matching system is configured to:
when a first offer of the supplier is registered, select information on the same or similar transaction history from previous transaction histories with reference to a transaction range or a minimum transaction price of the registered first offer, and recommend a calibration value for the transaction range or the minimum transaction price in the registered first offer; and
when the supplier agrees with the calibration on the transaction range or the minimum transaction price, set a second offer that results from calibration with the recommended calibration value for the transaction range or the minimum transaction price as a subordinate to the first offer, and register as the offer of the corresponding supplier.

8. The method of claim 1, wherein the matching system is configured to register a plurality of bids from a consumer participating in matching for online P2P energy transaction,
wherein each of the bids comprises information on a transaction range of transaction volumes and a transaction range of transaction prices which are individually determined, and
wherein the matching system is configured to, when the plurality of bids registered by the same consumer are prioritized for matching by the corresponding consumer, make the bids participate in matching in sequence from the highest priority bid, and, when one bid is matched, make the subordinate bids abstain from participating in matching.

9. The method of claim 8, wherein the matching system is configured to:
when a first bid of the consumer is registered, select information on the same or similar transaction history from previous transaction histories with reference to a transaction range or a minimum transaction price of the registered first bid, and recommend a calibration value for the transaction range of the transaction volumes or the transaction range of the transaction prices in the registered first bid; and
when the consumer agrees with the calibration on the transaction range of the transaction volumes or the transaction range of the transaction prices, set a second bid that results from calibration with the recommended calibration value for the transaction range of the transaction volumes or the transaction range of the transaction prices as a subordinate to the first bid, and register as the bid of the corresponding consumer.

10. A system for matching suppliers and consumers for online P2P energy transaction, the system comprising:
a collection unit configured to collect information on a transaction range presented by an offer from a supplier, and information on a transaction range presented by a bid from a consumer; and
a processor configured to determine an optimal transaction volume between the supplier and the consumer, based on the information on the transaction ranges of the offer and the bid.

11. A method for matching suppliers and consumers for online P2P energy transaction, the method comprising:
selecting, by a matching system, a matchable bid with reference to a transaction range of an offer by using information on a transaction range presented by an offer from a supplier, and information on a transaction range presented by a bid from a consumer; and
when a plurality of bids are selected, determining, by the matching system, an optimal transaction bid by considering transaction volumes and transaction prices of the plurality of bids, respectively.
